(19) United States
(12) Patent Application Publication
(10) Pub. No.: US 2011/0052769 A1
(43) Pub. Date: Mar. 3, 2011

(54) PROCESS FOR SPRAYING NATAMYCIN ONTO BAKERY PRODUCTS AND USE OF HEAT FOR THE REMOVAL OF SOLVENT FROM BAKED PRODUCTS

(75) Inventors: Peter Wisler, Dyssegaard (DK); Tania Serovski, Botany (AU); John Michael Ellis, Singapore (SG)

(73) Assignee: Danisco A/S, Copenhagen K (DK)

(21) Appl. No.: 12/530,163

(22) PCT Filed: Mar. 10, 2008
(86) PCT No.: PCT/EP2008/052819

§ 371 Date: Sep. 17, 2010

(30) Foreign Application Priority Data
Mar. 9, 2007 (FI) 20075167

(51) Int. Cl. A21D 2/08; A21D 6/00

(52) U.S. Cl. 426/241; 426/310

(57) ABSTRACT

The present invention provides a process for increasing the shelf life of bakery products, comprising baking a shaped dough in an oven; placing the shaped baked product on a bed, spraying a solution or suspension of natamycin in a solvent onto the surfaces of said shaped baked product, said spray being provided from sprayers located in at least two directions so as to deposit natamycin in an amount from 0.5 to 10 μg per cm² of surface area, and removing sprayed natamycin solvent from said surfaces. According to an embodiment of the invention, the solvent is removed by means selected from heat, blowing, micro waves and any combination thereof. The present invention further relates to the use of the heat in a hot baked bakery product for the removal of natamycin solvent sprayed onto the surfaces of said bakery product.

### BACKGROUND OF THE INVENTION

The present invention relates to a process for increasing the shelf life of bakery products and to the use of heat for the removal of a natamycin solvent sprayed onto the surfaces of said bakery product.

Many industrially produced baked goods emerge from the baking process with a surface that is essentially sterile but post bake handling can quickly lead to fungal surface contamination as a result of exposure to air borne contaminants as well as equipment contact. Following surface contamination on the product surface and between slices, many baked goods are then very vulnerable to surface mould spoilage right after they come out from the oven, the severity of which is linked to factors such as the degree of contamination, the moisture content of the product and the storage conditions. Baked products with a relatively neutral pH, high moisture content and high water activity such as cakes, muffins, waffles, and tortillas are particularly prone to rapid spoilage from a variety of moulds, principally Penicillium and Aspergillus species. Manufacturing good tasting, high moisture products with a long mould free shelf life presents a constant and ongoing technical challenge to the baking industry. The potential spoilage results in significant number of returns from retailers within shelf life to prevent customer complaints, adding the cost of quality at manufacturer.

Various methods have been adopted in an attempt to achieve the required shelf life. These include addition of humectants to reduce the water activity, addition of chemical mould inhibiting preservatives such as propionates or sorbates limiting the availability of oxygen via modified atmosphere packaging and active packaging containing oxygen scavengers or providing a saturated ethanol headspace in the pack using sachet or strip inserts containing ethanol. The chemical preservatives such as sorbate and propionate are most effective at low pH so acids are often added in combination with these preservatives to reduce the pH of the baked product and hence improve the effectiveness of the added preservative.

Addition of acids, chemical preservatives and humectants can affect the taste and quality of the product and their use is often a compromise between achieving the best tasting product and the longest possible shelf life. Preservation based on packaging systems rely very much on pack integrity and even the best systems can suffer shelf life failures due to pack damage or seal failures and hence loss of pack integrity. Thus, there remains the technical problem of providing an efficient preservation system, which will not adversely affect the taste of baked goods.

Natamycin is a polyene macrolide natural anti-fungal agent produced by fermentation of the bacterium Streptomyces natalensis. Natamycin (previously known as pimaricin) has an extremely effective and selective mode of action against a very broad spectrum of common food spoilage yeasts and moulds with most strains being inhibited by concentrations of 1-40 ppm of natamycin.

Natamycin has been used for many years in a large number of countries throughout the world as an authorized preservation treatment for cheeses and certain meat products such as dried sausages. Despite this long-term use, the development of resistant strains has not been reported to date unlike the chemical organic acid sorbate and propionate preservatives for which a number of resistant yeasts and moulds have been detected and reported. Some species of Penicillium mould are even able to degrade and metabolise sorbate.

Natamycin is much less soluble in water than the chemical organic acid preservatives with its maximum solubility being around 40 ppm. In practice this means that when applied to the surface of the cheese or sausage, natamycin shows very limited diffusion and tends to stay on the surface of the food. Natamycin is active over a wide pH range and unlike the organic acid preservatives it is not dependant on a low pH acidic environment to show good anti-fungal activity. The effectiveness of natamycin at very low application levels on cheese and sausage has not been reported to have any adverse quality or flavour impact on the products.

Although natamycin has been used for a long time on cheese and on sausages, there is very little reported on the use of natamycin for other types of food. According to a review article in the 1974 edition of the Encyclopaedia of Food Technology by A. H. Johnson and M. S. Peters, natamycin (pimaricin) is permitted in several countries as a food additive and it is either added into the food (e.g. orange juice, wine) or the food is dipped, soaked or sprayed with aqueous natamycin (e.g. cheese, sausage, fruit). The high potency of natamycin and the insoluble nature of natamycin in water make the uniform application on food products difficult, resulting in inappropriate applications. To overcome the problems the FDA has amended the food additive regulations to allow use of a dry form of natamycin.

Natamycin is heat-sensitive, which means that the effectiveness is effected already by exposure to heat above 50° C. for periods of more than 24 hours due to the hydrolysis of the ring structure. Natamycin is unaffected by short periods of exposure to temperatures up to 100° C. meaning that in can be pasteurised without significant loss of activity. This means that when natamycin is added to the dough prior to or during baking, it is substantially reduced in activity.

Natamycin is an approved food additive with the EU additive number E235 prescribed to it. More than 40 countries around the world have approvals for use in various food categories. In Australia and New Zealand, natamycin is currently approved for food use on cheese and specific processed meat surfaces. The joint FAO/WHO Expert Committee on Food Additives has set an acceptable daily intake of 0.3 mg per Kg body weight per day for natamycin. Application of natamycin to bread surfaces is likely to result in an average estimated daily intake (EDI) of 1.6 mg natamycin (assuming that all bread consumed is treated with natamycin which is very unlikely).

US 2004/0013781 discloses a fully baked bread product which remains soft for an extended shelf life. The bread may be protected by a microbial inhibitor which may be natamycin. In the described embodiments the inhibitor is included in the dough at baking. However, there is also a suggestion that a potassium sorbate inhibitor may be sprayed in an aqueous solution on the bread after baking.

Natamycin has been proposed for use for increasing the shelf life of fine bakery products which have an intermediate or high moisture (US 2005/0163895).

US 2006/0165857 discloses a bakery product which is protected by natamycin against spoilage, said natamycin being evenly distributed on the surface on an effective amount to inhibit the mold growth.

WO 2005/032259 and WO 2006/116364 both disclose a mold controlling and extending shelf-life methods and compositions for preparing dough-based products by treating the surface of the dough with at least one preservative and at least one pH adjusting agent prior to or during baking.

In the U.S. the direct addition of natamycin into tortilla dough before baking is allowed. Tortilla dough is leavened without yeast and therefore adding natamycin into the tortilla dough is possible. In yeast leavened doughs, natamycin cannot be used since the natamycin would kill the yeast. Because of this limitation of using natamycin in yeast leavened bakery, natamycin seems to have been tested on the surface of yeast leavened bread. Thus, the review in the above mentioned 1974 Encyclopaedia also mentions that “rye and white bread were well protected when their surfaces were sprayed with a solution of 100-500 ppm pimaricin”. No specific results are quoted to support the “well protected” comment and no reference is quoted for this work. No target levels for natamycin/pimaricin on the surface of the bread are given, no method of spraying and no shelf life targets are mentioned. In a later update of this review article for the same Encyclopaedia there was no mention of this bakery work. The review also makes similar vague references to treating the surface of uncooked doughs and to direct addition at 25-50 ppm in fillings for cakes and pies.

The direct addition of natamycin into icings and fillings of cakes is described also by 3. Tichá in Mlynsko-pekarensky promysl, 7/1975, pp 225-228, as being effective in preventing the growth of moulds and yeasts for about 14 days. The article concludes that natamycin in admixture with lactose is useful to preserve curd fillings, icings and butter creams.

The addition of natamycin to protect the fillings of Cantonese mooncakes and pastry is allowed according to Chinese legislation. However, the mooncakes themselves often have a fairly low water activity and are thus not as prone to spoil as the fillings, which are often made of easily perishable foodstuffs.

Many bakery products are required to have a very long shelf life, e.g. up to 2 to 10 weeks and sometimes longer at ambient temperature. The high water content of many bakery products makes them very sensitive to spoilage due to mould and yeast growth. This is especially true when the water activity of the product A_{w} is between 0.75 and 0.95.

There is a continuous need to increase the shelf life of bakery products having a tendency to mould growth whilst optimising on desirable product characteristics such as pH and taste.

Documents cited in this text (“herein cited documents”), as well as each document or reference cited in each of the herein-cited documents, and all regulations, manufacturer's literature, specifications, instructions, product data sheets, material data sheet, and the like, as to each product mentioned in this text, are hereby expressly incorporated herein by reference.

### BRIEF SUMMARY OF THE INVENTION

Natamycin is sensitive to the high temperatures used in baking and it is therefore suggested to apply natamycin after the baking process. However, many baked products have an unusual shape with irregular surfaces that can lead to shadowing effects when sprayed in a conventional manner. The present inventors have noted that shaped baked product which have been sprayed with natamycin from at least two directions have a more even surface coverage and are less prone to grow mould spots during storage. Spraying natamycin from several directions avoids areas with insufficient natamycin while at the same time avoiding too much natamycin being deposited over the entire product in an attempt to get a sufficient protection by one spray nozzle.

Spraying an excessive amount of aqueous natamycin should be avoided, since this would result in excessive surface moisture. Ideally, the spraying of natamycin should not increase the moisture of the baked product, since a higher moisture level increases the risk for mould growth.

A problem relating to the spraying of a natamycin solution or suspension onto bakery products lies in the wetting of the surfaces of the sprayed product by the solvent. The most typically used solvent for natamycin is water. An increase in the moisture content of the product and especially of the crust may be detrimental to the mouth-feel and appearance of the product. In many bakery products a crispy crust is required and a sodden crust is neither tasty nor good-looking. Furthermore, an increase in the moisture content of the surfaces of the product increases the risk for mold growth.

In the prior art spraying of cheese, e.g. shredded cheese, there is not the same problem with surface wetting. Shredded cheese has no crust and is not as sensitive to surface moisture as a bakery product. As the shredded cheese is tumbled during or after the spraying, the moisture spreads evenly in the product. The shredded cheese also contains anti-caking agents, which absorb moisture and thus reduce any negative effect of added moisture.

It has been surprisingly found out that even though natamycin is heat sensitive and there was a risk of causing loss of activity, heat can be utilized for removing the solvent from the sprayed surface.

It has also been found that by actively removing solvent sprayed onto the bakery product with the natamycin, a better mouth-feel, a better appearance and an improved mould protection of the bakery product is obtained.

The present invention provides a process for increasing the shelf life of bakery products, comprising baking a shaped dough in an oven; placing the shaped baked product on a bed, spraying a solution or suspension of natamycin in a solvent onto the surfaces of said shaped baked product, said spray being provided from sprayers located in at least two directions so as to deposit natamycin in an amount from 0.5 to 10 μg per cm² of surface area, and removing sprayed natamycin solvent from said surfaces.

According to an embodiment of the invention, the solvent is removed at least 40%, preferably at least 60%, more preferably at least 75% and most preferably at least 95% by means selected from heat, blowing, micro waves and any combination thereof. Preferably said solvent is removed by heat in the baked product itself. In one embodiment the heat in the product is provided by the heat remaining after baking and said spraying is performed before the surfaces of said product have cooled to a temperature below 50° C.

In a preferred embodiment of the invention, the amount of water deposited on said shaped products increases the A_{w} of the crust of said shaped baked product less than 5% as compared to a non-sprayed control product, both measured after cooling to ambient temperature. Preferably the A_{w} of the crust of said sprayed baked product is no more than 5 to 10% and more preferably 0-5% higher than the A_{w} of a non-sprayed control product. Most preferably the A_{w} of the said product is no higher than the A_{w} of the non-sprayed control product meaning, that there is no noticeable increase in the moisture of the product as a whole.

The present invention further relates to the use of the heat in a hot baked bakery product for the removal of natamycin solvent sprayed onto the surfaces of said bakery product. In the preferred embodiment of the invention, the solvent is removed by evaporation.

The increase of mould-free shelf life achieved by the present invention is of immense significance to the baking industry and will allow the replacement of chemical preservatives such as propionate, benzoate and sorbate with natamycin, a less toxic, tasteless and naturally occurring alternative. The present invention provides an improvement over the prior art of spraying natamycin on baked goods because it provides spraying of the shaped goods from different directions and onto hot products directly after baking. Even though this requires prospective users to invest in suitable spraying equipment that can deliver an even natamycin application to all surfaces of bakery products close to the bakery line, the advantages of natamycin are seen to outweigh the disadvantages of its use.

Without wishing to be bound by any theory, it is believed that when a natamycin spray is applied to the hot surface of the baked product, any water or other solvent included in the spray is evaporated and thus the moisture of the crust is not unduly increased. Furthermore, it is believed that as the solvent evaporates from the hot surface, the surface itself is cooled down enough to keep natamycin effective regardless of the exposure to heat.

### DETAILED DESCRIPTION OF THE INVENTION

When natamycin in a solvent such as water is sprayed onto bakery products the solvent causes wetting of the surfaces of the sprayed product. An increase in the moisture content of the product and especially of the crust may be detrimental to the mouth-feel and appearance of the product. In many bakery products a crispy crust is required. An increase in the moisture content of the surfaces of the product also increases the risk for mold growth. It has now been found that by actively removing solvent sprayed onto the bakery product with the natamycin, a better mouth-feel, a better appearance and an improved mould protection of the bakery product is obtained.

Another problem in connection with the spraying of natamycin onto the surface of baked products lies in the fact that natamycin does not spread over and through the surface like many other chemical preservatives used in this field, i.e. sorbates and propionates. When natamycin is applied to the surface it stays in the position where it was deposited. In the present invention, the problem of uneven distribution of natamycin placed onto the surface of baked product has been solved by spraying the solution from sprayers located in at least two directions to allow sufficient coverage. According to a preferred embodiment of the present invention, the spray is provided from at least 2 directions, most preferably the spray is provided from sprayers located in 3 to 6 directions so as to deposit natamycin uniformly on the surfaces of the baked product.

The prior art has sprayed natamycin onto the surface of warm bakery products after baking. However, bakery products taken out of an oven may have a surface temperature that is harmful to natamycin, which is known to be sensitive to heat. Therefore care was taken in the prior art to allow the bakery product to cool so that they were warm (typically 30 to 40° C. and in any case below 50° C.) but not longer hot (over 50° C.) so that the natamycin would not be destroyed. It has now surprisingly been found that when natamycin is sprayed in an evaporating solvent such as water, propylene glycol or ethanol, it can safely be sprayed onto a hot surface.

In the present process the heat actively removes the solvent of said natamycin solution or suspension from said surfaces. The solvent is removed by a means selected from heat, blowing, micro waves and combinations thereof. Preferably the solvent is removed by heat in the baked product itself. Heat may be provided by a means selected from heat in the product remaining after baking, heat in the product provided by micro waves, heat in a part of the product provided by blowing with a heating fan and combinations thereof. In a preferred embodiment the heat in the product is provided by the heat remaining after baking and said spraying is performed before the surfaces of said product have cooled to a temperature below 50° C.

The present invention is also related to the active use of heat in a hot baked bakery product for the removal of natamycin solvent sprayed onto the surfaces of said bakery product.

The spraying according to the invention is performed before said hot shaped baked products have cooled to a temperature below 50° C. The hot surface may have a temperature between 250 and 50° C., preferably to a temperature between 220 and 70° C. and most preferably to a temperature between 150 and 100° C. In a preferred embodiment, when the natamycin is slurried in water, the hot surface has a temperature between 150 and 110° C., which is sufficient to evaporate the added water. The spraying is preferably performed within one hour after the bakery product has been taken out of the oven. The temperature of the shaped baked product is most preferably selected to be high enough to evaporate the amount of water sprayed onto the hot product.

Consequently, the invention provides a process for producing a bakery product, the shelf life of which has been increased by the spraying of natamycin on the hot surface thereof. The preferred bakery products are intended for a long shelf life and having a moisture content which makes them susceptible to surface spoilage by moulds and yeasts. Such bakery products are especially those baked shaped products having a water activity A_{w} of 0.75-0.95 after cooling. In an embodiment of the invention said natamycin solution or suspension is an aqueous solution or suspension of natamycin. The amount of solvent and the temperature of the hot product should be selected so that the amount of water deposited on the hot shaped products increases the A_{w} of the crust of the shaped baked product less than 5% compared to a non-sprayed product. In a preferred embodiment the A_{w} of the crust of a sprayed baked product is no more than 5 to 10%, and preferably 0-5% higher than the A_{w} of a crust of a non-sprayed control product. Most preferably the A_{w} of the crust is not at all higher than the A_{w} of a non-sprayed control product, meaning that there is no noticeable increase in the moisture of the product as a whole.

The term “crust” when used herein refers to a thickness of the surface of the shaped product, which extends 2 mm from the surface towards the center of the baked product.

In a preferred embodiment natamycin is combined with at least one further antimicrobial agent, which either kill or slow the growth of microbes. The said antimicrobial agent is selected from salt, sorbates and benzoates. Natamycin can be further combined with a glacing ingredient, which provides a further protecting cover to bakery product. Said glacing agent is selected from salt, sugar, sugar glacings and egg-based or flavouring glacings.

The baked products are made from the dough which can be yeast leavened or non-yeast leavened. Preferably a shaped baked product comprises yeast leavened bread. The bread is selected from wheat bread, whole-wheat bread, rye bread, toast, bread loaves, pan bread, rolls, buns, burger rolls, bagette, pita bread, tin bread, scones, artisan bread, naan, namkeens, nankatais, khari, pizza, pies, crackers and biscuits, fruit bread, tortillas, Danish pasty, sweet doughs, laminated doughs, doughnuts, croissants, bagels, waffles, sandwich pouches, muffins, moon cakes, cakes, cookies and brownies.

The surface of the bakery product of the invention has deposited thereon an effective amount of natamycin which is sufficient to keep the product free of mould and yeast growth even though the product is packaged and stored for a long time at ambient temperature. The effective amount of natamycin on the surface of the finished product is between 0.5 and 10 μg per cm² and it is sufficient for keeping the baked product mould free for minimum of 60 days, when the product is stored at ambient temperature, which means a temperature between 15 and 30° C. and which more often is from 18 to 25° C.

When the process of the present invention is operated according to one embodiment, the shaped dough is baked in a hot oven at a temperature of 170 to 500° C. The shaped product is taken from the oven and placed on a bed and the outer surface of the shaped baked product is sprayed with natamycin solution or suspension before the surface has cooled down to a temperature below 50° C. The natamycin should be sprayed homogeneously on all outer surfaces of the baked product so as to protect the product all over. Natamycin has a very low tendency for migration in the product and will not spread far from the point of deposition. In order to provide a homogeneous deposition the spraying equipment should be carefully selected. The sprayers used may be similar or different and they are preferably selected from spraying guns, spinning disc spray systems, aerosol type spraying systems, vaporizing guns and combinations thereof as well as any other suitable spraying system that is capable of delivering a small but consistent and accurate spray volume over a given surface area. The spraying should be performed so that a preservatively effective amount of natamycin ranging from 0.5 to 10 μg/cm² and preferably 4-6 μg/cm² is deposited on the exposed surface of the product.

The sprayers should be located such that the spray is being provided from at least two directions. Preferably the spray is provided from sprayers located in 3 to 6 directions. The volume of the water based natamycin suspension sprayed onto the product should preferably be kept to the minimum level that will allow an even surface coverage. In a preferred embodiment, the natamycin deposited on the surface of the bakery product should be effective in keeping the bakery product mould free even when stored for minimum of 20 days, and even as high as 60 days.

In a preferred post baking spray system, the sprayers and the bed on which the baked products is placed, are arranged to move relative to one another. The bed may comprise moving conveyor moving past fixedly positioned spray nozzles or discs. The preferred sprayers comprise spinning discs positioned to deliver continuous bands of fine spray to one localized area on the conveyor from several directions at the same time. Preferably at least one of said sprayers is located so as to spray the under-side of said baked product. The baked product is typically sprayed on the bottom either through a conveyor gap or through a belt which is like a mesh, or the baked product is turned on the side or upside down and then sprayed. In a preferred embodiment a gap in a conveyor is used.

Natamycin solution is typically in the form of an aqueous solution, suspension or slurry of natamycin. The natamycin may also be dissolved, suspended or slurried in another solvent, such as an alcohol, which easily evaporates from the hot surface. Crystalline natamycin is sparingly soluble in water and the finely divided solid natamycin crystals will be deposited on the surface together with the water and the dissolved natamycin. A preferred aqueous natamycin suspension for spraying purposes contains natamycin in a concentration of 1 to 7 μg, more preferably 4 to 6 lag natamycin per millilitre of water. A very small amount of natamycin is required to provide the desired protection against spoilage by moulds and yeasts.

After spraying and cooling, the baked product may be sliced, if desired, and then packaged into a protective envelope, which is preferably made of a transparent material such as a plastic film or box to allow the presumptive buyer to view the product and be tempted by it. The films are generally of a moisture proof material to prevent the moist baked product from drying and loosing its softness during the several weeks of storing. During packing some preservatives, like nitrogen gas (in modified atmosphere) is sprayed into the package. Some breads are pasteurized after packing.

Results of tests performed with the spraying of natamycin onto hot bakery products shortly after baking show excellent correlation between treatment with Natamax™ SF (a natamycin product provided by Danisco A/S) and extension of shelf life via prevention of mould spoilage. It has been shown that a target application range of 4-6 μg/mL Natamax™ SF on bread crust will provide protection from mould growth in loaves for minimum of 60 days under expected handling and storage conditions—well above the customer's shelf life requirement of 12 days.

Use of Natamax™ SF as a spray treatment is a viable application to extend sliced bread shelf life and reduce the costs associated with bread returns. It also provides extended shelf life with end consumer after purchase, potentially reducing customer complaints and increasing customer satisfaction.

It has been noted that when an aqueous natamycin solution or suspension is spread in accordance with prior art on warm (30-40° C.) fine bakery products there is a risk for excessive wetting of the product. This will reduce the shelf life of the product sometimes to less than 3 weeks. It has now been found that spraying a similar solution or suspension on hot bread (110-120° C.) quickly causes the added moisture to evaporate and the bread has remained mould free for more than 60 days.

The following Examples illustrate the invention.

### Example 1

Wheat bread is baked in tins in an oven at 250° C. The bread is detinned directly from the oven and placed on a tray. The bread is then immediately sprayed with a freshly prepared aqueous natamycin slurry containing 2300 ppm Natamax™ SF (Danisco A/S) (1.15 g Natamax™ SF in 500 ml salted water—8%). The surface temperature of the loaves at the spraying is 125° C.±20° C.

The breads are provided in 3 batches:
Batch one—control (air sprayed)
Batch two—control (water sprayed)
Batch three—trial (natamycin sprayed)

Each batch is managed independently to ensure quickest delivery to sprayers whilst the bread is hot.
8 samples of control (air spray), 8 samples (water spray), then 8 samples (natamycin spray) are taken.

Two spray guns are positioned to spray the surfaces of the loaves evenly as the loaves are moved relative to the guns. The spray equipment is calibrated to deliver 4 to 6 μg/cm² of Natamax™ SF to the surface area of the baked bread. The underside of the baked bread is sprayed through a gap in a conveyor.

The bread is then placed on racks for cooling and slicing. The bread is manually handled and sliced in an industrial slicer. Then each loaf is hand packed into a clear plastics bag, which is secured with a plastic tie once cooled. The sliced packs of bread are placed in bakery racks for storage and transport.

In the shelf life test, the bread samples are tested using elevated storage (12 days, 30° C.) and ambient storage (12 days). Mould spoilage results and natamycin retention levels are monitored immediately after packaging and at the end of shelf life. Evaluation of the bread is continued until moulded. The samples are inspected every day from day 8 for mould growth.

The natamycin level is tested by slicing of the surface area (2 mm crust) and extracting natamycin. The amount of natamycin is analysed by HPLC. The results are expressed as μg/cm².

The results of the tests are shown in the enclosed Table 1.

Control samples of bread (untreated, treated with water) begin to show moulding from day 8, with the majority of samples considered spoiled by day 11. All control samples display mould growth by day 13 of the trial. Once mould growth starts it spreads to cause extensive spoilage across crusts within 2-3 days and internal contamination within 4 days.

Bread treated with Natamax™ SF shows no moulding on any packages for 18 days after production. One package shows mould at a broken corner on day 18. All other Natamax™ SF treated packages are still mould free on day 60 of the trial (trial is closed on this day).

Natamax™ SF application concentrations are between 6.1 and 7.6 μg/cm² which is close to the target range of 4-6 μg/cm². Tests are performed on Day 1 and Day 12 of the trial to determine any loss of Natamycin activity. There is no significant change in analytical results.

### Example 2

Loaves are baked and detinned in the same manner as in Example 1. Two spinning disc sprayers are placed on either side of a slowly moving conveyor of a post-baking line and one spinning disc sprayer is placed below the conveyor. The spinning disc sprayers are calibrated to deliver 4 to 6 μg/cm² Natamax™ SF (Danisco A/S) to the surface of baked bread having a surface temperature of 100±20° C.

Spraying of the aqueous natamycin slurry of Example 1 sprays also water onto the surface. Because of the hot surface, most of the water immediately evaporates off. The water activity A_{w} is measured for each type of bread before spraying, 5 minutes after spraying and after cooling to ambient temperature. The A_{w} of the loaves is, on an average 0.80. The spraying on the hot baked bread evaporates the added water very quickly and the increase in A_{w} after 5 minutes is found to have increased the A_{w} with about 3-4% for water-sprayed and natamycin-sprayed loaves compared to a non-sprayed (air-sprayed) control loaf. When the loaves have cooled to ambient temperature, the difference in A_{w} between sprayed and non-sprayed loaves is within the normal variation and no increase by the water spraying nor by the natamycin spraying can be detected.

TABLE 1
NATAMAX ™ SF APPLIED TO SLICED BREAD

| | | | | Visual results | | | | | | | |
|---|---|---|---|---|---|---|---|---|---|---|---|
| Sample | | Storage | Test Time | (X - none, ✓ - spoilage) | | | | | | | |
| Ref | Description | Condition | (natamycin) | Day 8 | Day 9 | Day 10 | Day 11 | Day 13 | Day 14 | Day 16 | Day 18 |
| GFC01 | Control - no spray | None | Immediate | | | | | | | | |
| GFC02 | Control - no spray | Ambient | Day 12 | ✓ | ✓ | ✓ | ✓ | | | | |
| GFC03 | Control - no spray | Ambient | | X | X | ✓ | ✓ | ✓ | ✓ | ✓ | ✓ |
| GFC04 | Control - no spray | Ambient | | ✓ | ✓ | ✓ | ✓ | ✓ | ✓ | ✓ | ✓ |
| GFC05 | Control - no spray | Ambient | | ✓ | ✓ | ✓ | ✓ | ✓ | ✓ | ✓ | ✓ |
| GFC06 | Control - no spray | Ambient | | ✓ | ✓ | ✓ | ✓ | ✓ | ✓ | ✓ | ✓ |
| GFC07 | Control - no spray | 30° C. | | X | X | X | X | ✓ | ✓ | ✓ | ✓ |
| GFC08 | Control - no spray | 30° C. | | X | X | X | ✓ | ✓ | ✓ | ✓ | ✓ |
| GFW01 | Control - water spray | None | Immediate | | | | | | | | |
| GFW02 | Control - water spray | Ambient | Day 12 | X | X | ✓ | ✓ | | | | |
| GFW03 | Control - water spray | Ambient | | ✓ | ✓ | ✓ | ✓ | ✓ | ✓ | ✓ | ✓ |
| GFW04 | Control - water spray | Ambient | | ✓ | ✓ | ✓ | ✓ | ✓ | ✓ | ✓ | ✓ |
| GFW05 | Control - water spray | Ambient | | ✓ | ✓ | ✓ | ✓ | ✓ | ✓ | ✓ | ✓ |
| GFW06 | Control - water spray | Ambient | | X | X | X | ✓ | ✓ | ✓ | ✓ | ✓ |
| GFW07 | Control - water spray | 30° C. | | X | X | X | X | X | ✓ | ✓ | ✓ |
| GFW08 | Control - water spray | 30° C. | | ✓ | ✓ | ✓ | ✓ | ✓ | ✓ | ✓ | ✓ |
| GFN01 | Natamax SF spray | None | Immediate | | | | | | | | |
| GFN02 | Natamax SF spray | None | Immediate | | | | | | | | |
| GFN03 | Natamax SF spray | Ambient | Day 12 | X | X | X | X | | | | |
| GFN04 | Natamax SF spray | Ambient | | X | X | X | X | X | X | X | X |
| GFN05 | Natamax SF spray | Ambient | | X | X | X | X | X | X | X | X |
| GFN06 | Natamax SF spray | Ambient | | X | X | X | X | X | X | X | X |
| GFN07 | Natamax SF spray | Ambient | | X | X | X | X | X | X | X | X |
| GFN08 | Natamax SF spray | 30° C. | | X | X | X | X | X | X | X | X |
| GFN09 | Natamax SF spray | 30° C. | Day 12 | X | X | X | X | | | | |

| Sample | Natamycin | |
|---|---|---|
| Ref | Conc. μg/cm² | Comments |
| GFC01 | 0 | Nil added - OK |
| GFC02 | 0 | Green mould on 2 sides - 2-3 mm |
| GFC03 | | Green mould on end and side - 2-3 mm |
| GFC04 | | Green mould on top end - 2 mm |
| GFC05 | | Rough Handling - Green mould on 2 sides - 3 mm |
| GFC06 | | Rough handling - Green mould on side - 2-3 mm |
| GFC07 | | Green mould on end & side - 3 mm |
| GFC08 | | Large green spreader mould on side |
| GFW01 | 0 | Nil added - OK |
| GFW02 | 0 | Green mould on end and sides - 2-3 mm |
| GFW03 | | Green mould on 2 sides - 3 mm |
| GFW04 | | Green mould on end and sides - 2-3 mm |
| GFW05 | | Rough handling - Green mould on end and sides - 2 mm |
| GFW06 | | Rough handling - Green mould on end - 3 mm |
| GFW07 | | Green mould on end & sides - 2 mm |
| GFW08 | | Lge white spreader mould on 2 sides, lge green and |
| | | yellow spreader mould on side |
| GFN01 | 6.1 | Close to desired range - tested Day 1 |
| GFN02 | 6.9 | Close to desired range - tested Day 1 |
| GFN03 | 6.4 | Close to desired range - tested Day 12 |
| GFN04 | | Still mould free - Day 60 |
| GFN05 | | Rough handling simulation Still mould free - Day 60 |
| GFN06 | | Rough handling simulation |
| | | Mould appeared Day 18 at broken corner |
| GFN07 | | Still mould free - Day 60 |
| GFN08 | | Still mould free - Day 60 |
| GFN09 | 7.6 | Close to desired range - tested Day 12 |

1. A process for increasing the shelf life of bakery products, comprising
baking a shaped dough in an oven
placing the shaped baked product on a bed
spraying a solution or suspension of natamycin in a solvent onto the surfaces of said shaped baked product
said spray being provided from sprayers located in at least two directions so as to deposit natamycin on said surfaces in an amount from 0.5 to 10 μg per cm² of surface area, and
removing sprayed natamycin solvent from said surfaces.

2. A process according to claim 1, wherein said solvent is removed by a means selected from heat, blowing, micro waves and combinations thereof.

3. A process according to claim 2, wherein said solvent is removed by heat in the baked product itself.

4. A process according to claim 3, wherein said heat is provided by a means selected from heat in the product remaining after baking, heat in the product provided by micro waves, heat in a part of the product provided by blowing with a heating fan and combinations thereof.

5. A process according to claim 4, wherein the heat in the product is provided by the heat remaining after baking and said spraying is per formed before the surfaces of said product have cooled to a temperature below 50° C.

6. A process according to claim 1, wherein said natamycin solution or suspension is an aqueous solution or suspension of natamycin.

7. A process according to claim 6, wherein the amount of water deposited on said shaped products increases the A_{w} of the crust of said shaped baked product less than 5% as compared to a non-sprayed control product, both measured after cooling to ambient temperature.

8. A process according to claim 1, wherein said natamycin is combined with at least one further antimicrobial agent in said solution or suspension.

9. A process according to claim 8, wherein said antimicrobial agent is selected from salt, sorbates and benzoates.

10. A process according to claim 1, wherein said natamycin is combined with a glacing ingredient in said solution or suspension.

11. A process according to claim 10, wherein said glacing ingredient is selected from salt, sugar, sugar glacings and egg-based or flavouring glacings.

12. A process according to claim 1, wherein said dough is a yeast leavened or non-yeast leavened dough.

13. A process according to claim 1, wherein said shaped baked product comprises yeast leavened bread.

14. A process according to claim 13, wherein said bread is selected from wheat bread, whole-wheat bread, rye bread, toast, bread loaves, pan bread, rolls, buns, burger rolls, bagette, pita bread, tin bread, scones, artisan bread, naan, namkeens, nankatais, khari, pizza, pies, crackers and biscuits, fruit bread, tortillas, Danish pasty, sweet doughs, laminated doughs, doughnuts, croissants, bagels, waffles, sandwich pouches, muffins, moon cakes, cakes, cookies and brownies.

15. A process according to claim 13, wherein said bread is sliced before said packaging.

16. A process according to claim 5, wherein said spraying is performed on a hot shaped baked product before it has cooled to a temperature between 250 and 50° C., preferably to a temperature between 220 and 70° C. and most preferably to a temperature between 150 and 100° C.

17. A process according to claim 5, wherein said spraying is performed within one hour after said bakery product has been taken out of said oven.

18. A process according to claim 17, wherein the temperature of said shaped baked product is selected to be high enough to evaporate the amount of water sprayed onto the hot product.

19. A process according to claim 1, wherein the A_{w} of the baked shaped product, after cooling is between 0.75 and 0.95.

20. A process according to claim 19, wherein the A_{w} of the crust of said sprayed baked product is no more than 5 to 10%, and preferably 0-5% higher than the A_{w} of a non-sprayed control product.

21. A process according to claim 19, wherein the A_{w} of said product is no higher than the Aw of a non-sprayed control product.

22. A process according to claim 1, wherein said sprayers are similar or different and are selected from spraying guns, spinning disc spray systems, aerosol type spraying systems, vaporizing guns and combinations thereof.

23. A process according to claim 1, wherein said sprayers and said bed are arranged to move relative to one another.

24. A process according to claim 23, wherein said bed comprises a moving conveyor.

25. A process according to claim 24, wherein said sprayer comprises spinning discs positioned to deliver continuous bands of fine spray to one localized area on said conveyor from several directions at the same time.

26. A process according to claim 1, wherein said spray is provided from sprayers located in 3 to 6 directions so as to deposit natamycin uniformly on the surfaces of the baked product.

27. A process according to claim 1, wherein at least one of said sprayers is located so as to spray the under-side of said baked product.

28. A process according to claim 1, wherein said sprayed shaped baked product (s) is/are packaged into protective envelopes.

29. (canceled)
